(19) United States
(12) Patent Application Publication
(10) Pub. No.: US 2006/0169341 A1
(43) Pub. Date: Aug. 3, 2006

(54) Internally damped laminated tube

(75) Inventors: Gregory M. Goetchius, Oaklnad, MI (US); James R. Schwaegler, Canton, MI (US)

Correspondence Address: Quinn Law Group, PLLC., Suite # 520, 39555 Orchard Hill Place, Novi, MI, 48375, US

(73) Assignee: Material Sciences Corporation

(21) Appl. No.: 11/047,831

(22) Filed: Feb. 1, 2005

(51) Int. Cl. F16L 55/04

(52) U.S. Cl. 138/30; 138/141

(57) ABSTRACT

An internally damped laminated tube comprises an outer layer and an inner layer, with a viscoelastic layer disposed therebetween. The outer and inner layers constrain the viscoelastic layer, thereby providing noise and vibration reduction through constrained-layer damping. While both the outer and inner layers act as constraining layers, the outer layer also preferably provides structural support for the tube, thus necessitating a thicker outer layer. Preferably, the outer and inner layers comprise steel. The internally damped tube according to the present invention exhibits a composite loss factor greater than four percent for ring modes occurring at vibrational frequencies between 700 and 950 Hz.

### TECHNICAL FIELD

The present invention relates to an internally damped laminated metal tube designed for noise reduction and vibration damping.

### BACKGROUND OF THE INVENTION

Metal tubes are often used in applications where dynamic loads are applied to the tubes. At various resonances, the dynamic loads cause excess noise and vibration in the tubes. Much effort has been exerted to reduce or eliminate the negative effects of tube resonances. Tube resonances include the “bending” and “torsion” resonances of the tube, as well as the “ring” modes or “shell” modes of the tube, the latter occurring at higher frequencies and smaller wavelengths than the bending and torsion modes.

Traditionally, parts or materials are added to a main tube to reduce the tube resonances. For example, internal vibration absorbers generally comprise a cardboard tube inserted within the main tube to provide frictional damping. The cardboard tube provides low levels of frictional damping of high frequency ring modes. The cardboard tube may also be surrounded by rubber strips prior to insertion within the main tube. The rubber strips provide vibration reduction at specific frequencies, depending on their material properties. As another example, a damping sleeve may be preferred to improve bending and torsion resonances of the main tube. Traditionally, the damping sleeve is quite stiff, and surrounds the main tube to shift bending and torsion resonances, while providing very little damping. As a further example, external tube vibration dampers generally comprise ring dampers or tuned mass dampers. With ring dampers, an elastomeric material attaches a metal ring around the outside of the main tube to reduce vibrations at a specific frequency. In a tuned mass damped tube, an elastomeric material suspends a mass from the main tube. The mass is tuned to reduce vibrations at a specific frequency. Each of the resonance reducing structures described above increases the complexity, cost and weight of the main tube.

### SUMMARY OF THE INVENTION

Accordingly, the present invention provides an internally damped laminated tube comprising an outer layer and an inner layer, with a viscoelastic layer disposed therebetween. The outer and inner layers constrain the viscoelastic layer, thereby providing noise and vibration reduction through constrained-layer damping. The outer layer has a first thickness, while the inner layer has a second thickness less than the first thickness. Preferably, the first thickness is at least two times the second thickness. While both the outer and inner layers act as constraining layers, the outer layer also preferably provides structural support for the tube, thus necessitating a thicker outer layer. Preferably, the outer and inner layers comprise steel. The internally damped tube according to the present invention exhibits a composite loss factor greater than four percent for ring modes occurring at vibrational frequencies between 700 and 950 Hz.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 shows a schematic perspective view of an internally damped laminated tube according to the present invention; and

FIG. 2 shows a graph of composite loss factor as a function of frequency for the laminated tube of FIG. 1.

### DESCRIPTION OF THE PREFERRED EMBODIMENTS

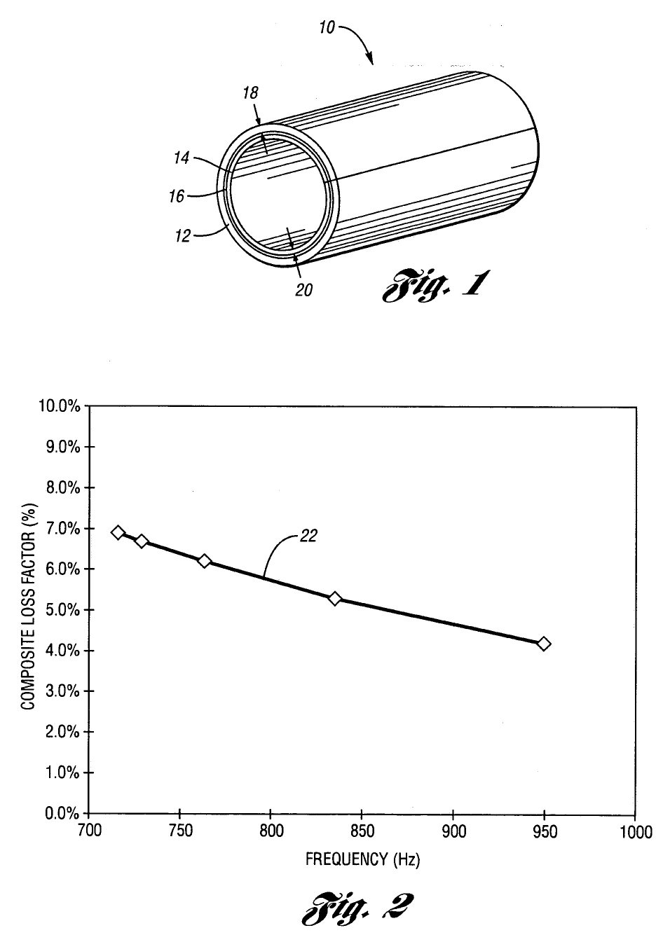

Referring to FIG. 1, an internally damped laminated tube according to the present invention is shown at 10. The tube 10 has an outer layer 12 and an inner layer 14, with a viscoelastic layer 16 disposed therebetween to provide internal damping as described herein. Preferably, the outer and inner layers 12, 14 are formed from steel. However, any material may be used to form the outer and inner layers 12, 14 without changing the inventive concept, with the material chosen dependent upon the structural properties necessary for the intended application. The viscoelastic layer 16 is a viscoelastic material as known in the art. Any viscoelastic material may be used for the viscoelastic layer 16, with the viscoelastic material chosen dependent upon the intended application.

Sandwiching the viscoelastic layer 16 between the outer and inner layers 12, 14 provides noise and vibration reduction from within the tube 10, thereby eliminating the need for additional parts or materials to provide damping. Specifically, the outer and inner layers 12, 14 act as constraining layers. The outer and inner layers 12, 14 tend to undergo deformation due to vibrational forces. Since the viscoelastic layer 16 is bonded to both the outer and inner layers 12, 14, deformation forces from the deformation of the outer and inner layers 12, 14 are transferred to the viscoelastic layer 16. The deformation forces shear across the viscoelastic layer 16, since the viscoelastic layer 16 is constrained by the outer and inner layers 12, 14. This shearing inside the viscoelastic layer 16 absorbs the deformation energy and dissipates it into heat, thereby damping noise and vibrations.

In the preferred embodiment, the outer layer 12 has a first thickness 18, while the inner layer 14 has a second thickness 20 less than the first thickness 18, thereby creating an asymmetrical laminate. Preferably, the first thickness 18 is at least two times the second thickness 20. The outer layer 12 is designed to carry structural loads while also acting as a constraining layer. In contrast, the inner layer 14 acts primarily as a constraining layer, while providing little structural support. Prior to development of the tube 10, it was widely believed that a laminated tube was not feasible, since two steel layers separated by a viscoelastic layer could not provide adequate structural support without substantially increasing the overall thickness of the tube. However, the asymmetrical configuration of the present invention allows internal damping without substantially increasing tube thickness, since the inner layer 14 need only be thick enough to induce a shear into the viscoelastic layer 16. The first and second thicknesses 12, 14 are chosen based on the desired application.

FIG. 2 shows a loss curve 22 for the preferred embodiment of the tube 10 of the present invention. The ability of a structure to damp vibrations is known as its “loss factor”, with a higher loss factor indicating greater damping capability. The loss factor for a given structure is a function of both temperature and vibrational frequency within the structure. To create the loss curve 22, a computer model of the tube 10 was constructed using Finite Element Analysis. Material properties for the preferred embodiment were entered into the model. The resulting loss curve 22 shows the loss factor computed by the model within the range of vibrational frequencies at which ring modes tend to occur. It can be seen from FIG. 2 that for ring modes occurring at vibrational frequencies between 700 and 950 Hz, the tube 10 exhibits a loss factor greater than four percent. It can also be seen that for ring modes occurring at vibrational frequencies between 700 and 850 Hz, the tube 10 exhibits a loss factor greater than five percent. Additionally, for ring modes occurring at vibrational frequencies between 700 and 750 Hz, the tube 10 exhibits a loss factor greater than six percent. Since ring modes occur at these higher frequencies, FIG. 2 shows that a tube 10 according to the present invention significantly damps the ring modes as compared to a standard steel tube, which typically exhibits a loss factor of less than one percent at the same frequencies.

While the tube 10 shown in FIG. 1 has a circular cross-section, a tube having any cross-section may be employed without changing the inventive concept. A tube 10 according to the present invention can be used in a variety of applications including but not limited to automotive drive shafts, exhaust systems, cross car beams, suspension cradles or subframes, chassis tubular cross-members between frame rails, and recreational vehicle handle bars. It should be noted that the inner layer 14 may be designed to carry structural loads, with the outer layer 12 acting primarily as a constraining layer, without changing the inventive concept. That is, the inner layer 14 could have the first thickness 18 and the outer layer could have the second thickness 20, such that the inner layer 14 is thicker than the outer layer 12. The inventive concept encompasses a tube of any shape comprising asymmetrical outer and inner layers with a viscoelastic layer disposed therebetween to provide internal damping.

The tube 10 is preferably formed from a laminated sheet structure commercially available under the product name Quiet Steel® from Material Sciences Corporation of Elk Grove Village, Ill. The laminated sheet structure comprises first and second cold rolled steel sheets having an engineered viscoelastic layer therebetween. In the preferred embodiment, wherein the tube 10 has a circular cross-section, the laminated sheet structure is first formed into a U-shape, and then into an O-shape, such that a first edge of the first steel sheet aligns with a second edge of the first steel sheet. Similarly, a first edge of the second steel sheet aligns with a second edge of the second steel sheet, and a first edge of the viscoelastic layer aligns with a second edge of the viscoelastic layer. The edges are then joined together to create the tube 10, with laser welding being the preferred method of joining. The edges of the steel sheets may be beveled such that the first and second edges are flush when aligned, thereby simplifying the welding process.

While the best mode for carrying out the invention has been described in detail, it is to be understood that the terminology used is intended to be in the nature of words and description rather than of limitation. Those familiar with the art to which this invention relates will recognize that many modifications of the present invention are possible in light of the above teachings. It is, therefore, to be understood that within the scope of the appended claims, the invention may be practiced in a substantially equivalent manner other than as specifically described herein.

1. An internally damped laminated tube comprising:
an outer layer having a first thickness;
an inner layer having a second thickness less than said first thickness; and
a viscoelastic layer disposed between and bonded to said outer layer and said inner layer to provide internal damping for said tube.

2. The internally damped laminated tube of claim 1, wherein said outer layer comprises steel.

3. The internally damped laminated tube of claim 1, wherein said inner layer comprises steel.

4. The internally damped laminated tube of claim 1, wherein said tube exhibits a composite loss factor greater than four percent for ring modes occurring at vibrational frequencies between 700 and 950 Hz.

5. The internally damped laminated tube of claim 4, wherein said tube exhibits a composite loss factor greater than five percent for ring modes occurring at vibrational frequencies between 700 and 850 Hz.

6. The internally damped laminated tube of claim 5, wherein said tube exhibits a composite loss factor greater than six percent for ring modes occurring at vibrational frequencies between 700 and 750 Hz.

7. The internally damped laminated tube of claim 1, wherein said first thickness is at least two times said second thickness.

8. The internally damped laminated tube of claim 1, wherein said tube has a generally circular cross-section.

9. An internally damped laminated metal tube comprising:
an outer layer comprising steel and having a first thickness;
an inner layer comprising steel and having a second thickness, said first thickness being at least two times said second thickness; and
a viscoelastic layer disposed between said outer layer and said inner layer;
said viscoelastic layer providing internal damping for said laminated metal tube, such that said tube exhibits a composite loss factor greater than four percent for ring modes occurring at vibrational frequencies between 700 and 950 Hz.

10. The internally damped laminated metal tube of claim 9, wherein said tube exhibits a composite loss factor greater than five percent for ring modes occurring at vibrational frequencies between 700 and 850 Hz.

11. The internally damped laminated metal tube of claim 10, wherein said tube exhibits a composite loss factor greater than six percent for ring modes occurring at vibrational frequencies between 700 and 750 Hz.

12. The internally damped laminated metal tube of claim 9, wherein said tube has a generally circular cross-section.

13. An internally damped laminated tube having a viscoelastic layer constrained between inner and outer steel tubes and exhibiting a composite loss factor greater than four percent for ring modes occurring at vibrational frequencies between 700 and 950 Hz.

14. The internally damped laminated tube of claim 13, wherein said outer steel tube has a first thickness for supporting structural loads on said tube, and wherein said inner steel tube has a second thickness less than said first thickness.

15. The internally damned laminated tube of claim 13, wherein said viscoelastic layer is sufficiently bonded to both said outer and inner layers when constrained so that deformation forces on said outer and inner layers are transferred to said viscoelastic layer.

16. The internally damped laminated tube of claim 1, wherein the thickness of one of said inner and outer layers is configured to support structural loads, and wherein both of said inner and outer layers are constraining layers for said viscoelastic layer.

17. The internally damped laminated metal tube of claim 9, wherein said first thickness is sufficient to support structural loads, and wherein both of said inner and outer layers are constraining layers for said viscoelastic layer.

18. The internally damped laminated tube of claim 13, wherein said outer steel tube is designed to carry structural loads while also acting as a constraining layer for said viscoelastic layer.
